(19) United States
(12) Patent Application Publication
(10) Pub. No.: US 2004/0158607 A1
(43) Pub. Date: Aug. 12, 2004

(54) System and method for associating an email attachment file with a storage location

(76) Inventors: Clifford L. Coppinger, Boise, ID (US); Kram H. Allen, Meridian, ID (US); Linn J. Kropf, Boise, ID (US)

Correspondence Address: HEWLETT-PACKARD COMPANY, Intellectual Property Administration, P.O.Box 272400, Fort Collins, CO, 80527-2400, US

(21) Appl. No.: 10/361,057

(22) Filed: Feb. 6, 2003

(51) Int. Cl. G06F 15/16

(52) U.S. Cl. 709/206

(57) ABSTRACT

A system and method are provided for associating an attachment file of an email with a separate storage location. The system and method can include the operation of storing the attachment file for the email in an electronic storage location. Another operation is selecting a user interface option connected to the email to initiate linking of the stored attachment file to the email. A further operation is connecting an access link referencing the stored attachment file to the email in order to link the attachment file in the electronic storage location to the email.

### FIELD OF THE INVENTION

The present invention relates generally to attachment files for email.

### BACKGROUND

Computerized electronic mailing or email systems have recently become an important part of the business workplace. Additionally, many people use email at home, while traveling, or for socializing. Not only is email a fast communication method but email enables computer users to send additional information along with a text message.

When an email user sends an electronic message to one or more recipients, the user can send a text message and include attachment files. Attachment files can include nearly any type of computer file or document that is stored on a computer storage device in an electronic format. Examples of files that users may email to other users are word processing documents, spreadsheets, digital images, and a multitude of other electronic files.

When a user receives an attachment file with an email, the email client software generally provides the user with some operations that can be performed on the attachment file. Many email clients allow the user to directly view the attachment file in a multi-function viewer. Multi-function viewers do not provide a significant amount of functionality but the multi-function viewers generally provide a static view of the attachment. Viewing the file allows a user to determine what the attachment is or what the attachment contains.

Another operation provided by the email client enables files to be opened based on the document's file extension or the operating system's classification of the file. In this situation, the application that the operating system associates with the attachment file (e.g., based on the file extension) is launched and then the attachment file is loaded into the application. This allows a user to perform application specific operations on the attachment file, when the appropriate application exists to open the attachment file. For example, a user who receives a word processing document may open the attachment file directly from the email and make changes to the document before saving the file. Users are also generally able to initiate the printing of the attachment either from the email viewer or from the document's application.

An additional function that email users can perform on their attachment files is the “Save As” operation. This function allows a user to save an attachment file from an email to a storage location designated by the user. When a user selects the menu option for saving the attachment, then a “Save As” dialog box is typically presented to the user. This “Save As” dialog box allows the user to navigate through their computer system and select an electronic storage location for saving the attachment file. For example, the user can save the attachment file on any device that the operating system treats as an electronic storage location or file system. Specific examples of electronic storage locations are the user's local hard drive or a mapped network drive where the user can save the file on a networked storage device.

Many computer users receive a relatively large volume of email correspondence. This means that the users receive a proportional number of attachment files with their email messages. These users also want to retain a copy of the attachment files that are received, especially if these attachment files are used for work projects or other record keeping purposes.

Some users may receive hundreds of attachments throughout the course of several weeks or months. As the attachments are received, a user typically saves these attachment files to a specific storage location. Unfortunately, if the user does not document where the attachment files are saved, a user can easily forget where files were saved. In the event the user forgets the storage location of the previously saved attachment file, the user must find the original email and resave that attachment file to another storage location. Not only is this process time consuming, but re-saving the attachment file is a waste of storage space. The end result is duplicate documents in different locations simply because a user cannot remember where the attachment file was saved. Not being able to locate an attachment file wastes a user's time and can even double the storage space needed for saving attachment files when an attachment file has been lost.

A different problem can arise for users who have a laptop computer loaded with an email client configured to operate in remote mode. In this situation, the email client on the user's laptop will connect to a network server's email application. When the laptop user desires to switch into remote mode, the email client copies all of the user's emails and attachments onto the laptop or “remote” computer. If the laptop user is already in remote mode, then new emails with attachment files can be downloaded via a modem or network connection and stored on the laptop. This means that duplicate copies of all the emails and attachment files are made on the laptop or remote computer. As a result, a large email folder is created for the remote email client, and this consumes a significant amount of storage resources on the remote email client's storage device or hard drive. An overly large email folder on a remote system can overburden the remote system's resources and consume limited storage space.

### SUMMARY OF THE INVENTION

The invention provides a system and method for associating an attachment file of an email with a separate storage location. The invention includes the operation of storing the attachment file for the email in an electronic storage location. Another operation is selecting a user interface option connected to the email to initiate linking of the stored attachment file to the email. A further operation is connecting an access link referencing the stored attachment file to the email in order to link the attachment file in the electronic storage location to the email.

### BRIEF DESCRIPTION OF THE DRAWINGS

FIG. 1 is a flow chart illustrating a method for associating an attachment file for an email with a storage location in accordance with an embodiment of the present invention;

FIG. 2 illustrates an embodiment of a user interface for associating an attachment file for an email with an access link; and

FIG. 3 is a block diagram illustrating a system for associating an attachment file for an email with an access link in an embodiment of the invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

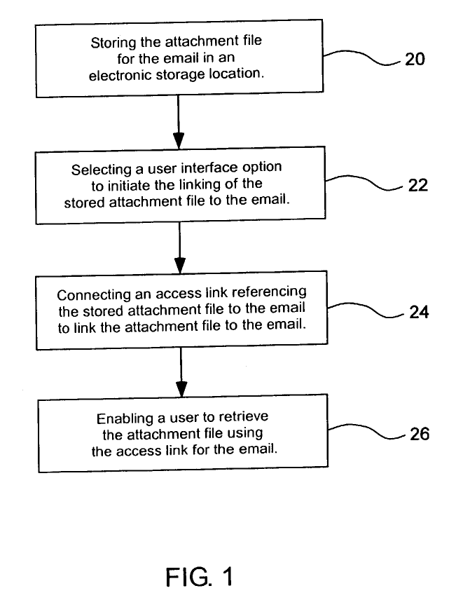

The present invention includes a system and method for associating an attachment file for an email with a separate storage location. One embodiment of a method for performing the invention is illustrated in FIG. 1. The method includes the operation of storing an attachment file for an email in an electronic storage location in block 20. The attachment file may be any electronic file that can be attached to an email. For example, a user may receive a word processing document, spreadsheet, web page, multimedia presentation, executable file, etc. The electronic storage location where the attachment file is stored may be a local storage device (e.g., a hard drive) or the electronic storage location may be a remote storage location, such as a network storage location (e.g. a network server).

Once the attachment file has been stored in a specific electronic location, a user interface option may be selected that is connected to the email in block 22. This user interface option can initiate the linking of the stored attachment file to the email. An access link is then connected to the email and the access link references the stored attachment file as in block 24. The access link is created in order to link the attachment file to the electronic storage location and provide this access link for the email. Once this access link has been provided, the system enables a user to retrieve the attachment file using the access link for the email 26.

Although the embodiment of the method discussed above has described the creation of the access link and the association between the access link and the email in a specific order, the steps discussed are not required to be performed in the order described. For example, the selection step in 22 may take place before the storing and connecting steps in 20 and 24. Alternatively, the selection and connection step may take place first and the storing step may take place last.

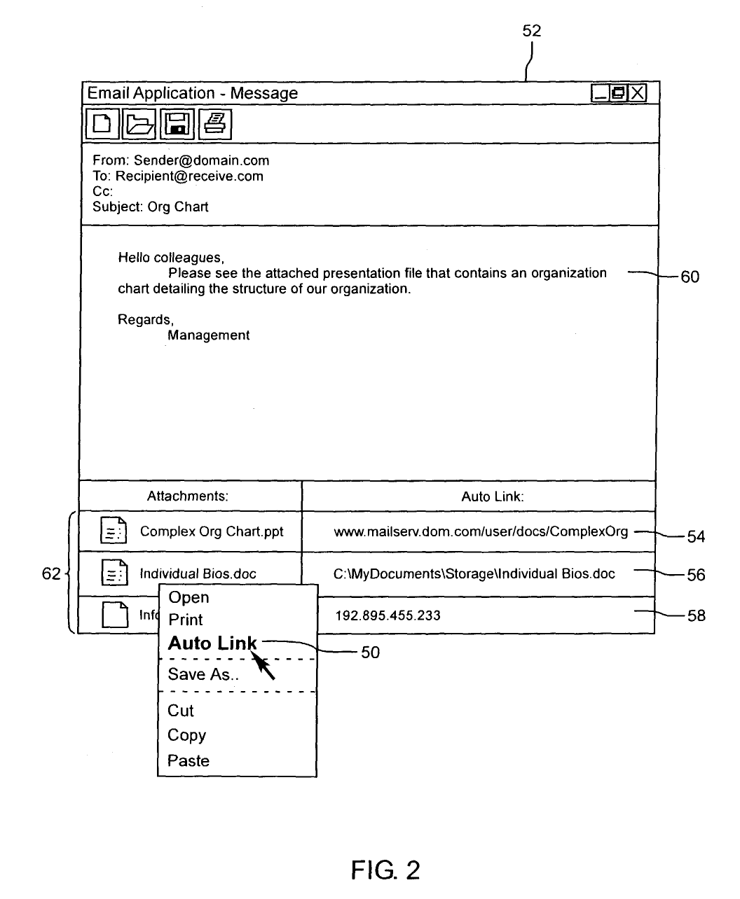

FIG. 2 illustrates an email 52 that has been received by a specific user or recipient. The email illustrated contains a text message 60 and a number of attachment files 62. An auto-link user interface 50 is provided which allows the user to link the attachment files for the email to an electronic storage location. The auto-link interface can be implemented as a pop-up menu, a hot-key, a window menu option, a pop-up window, or any other convenient user interface known to those skilled in the art. When an access link is created by a user's selection of the auto-link 50 feature, the system associates a link between the email and the stored attachment file. The access link may be embedded directly into the email as illustrated in FIG. 2 or the access link may be displayed when some user action is taken. In other words, the access link may be hidden until the user desires to see the access link. Alternatively, the access link can be displayed in its own independent window or user interface control that is tied to the respective email.

The access link can be a uniform resource locator (URL) or hyperlink as illustrated for the first attachment 54 in FIG. 2. Alternatively, the access link can be a local storage path 56 or an internet protocol (IP) address 58. The access link is configured to point to or reference an electronic storage location where the attachment file is stored.

The present invention stores the attachment file in a user specified electronic storage location. This electronic storage location is defined as being generally separate from the initial location where the network server's email application stores the email attachment file when the attachment file is first received. Alternatively, the separate electronic storage location may be in a special partition of the email application's database, but the electronic storage location is more useful in a location that is configured so a user can access the stored attachment file through a public network.

The electronic storage location may be a non-volatile electronic storage location such as a computer's hard disk, a network server's RAID array, network-attached storage (NAS), or even a Flash RAM. Alternatively, the access link can point to a volatile storage location such as a RAM disk or a similar location. The actual type of electronic storage location used is dependent upon the desired storage time and where the user wants to store the attachment file.

The electronic storage location can also be a mapped network drive for a network client. In the mapped drive situation, the network client's drives are generally mapped relative to the client's security rights. For example, a user's PC may have mapped drives named G, H or I and the attachment file can be stored on any of those mapped locations where the client has security rights. Alternatively, the attachment file can be stored in a local or networked database. In any of these storage embodiments discussed, the access link can be used by the operating system or a given communication protocol to store the file and then retrieve the file from the electronic storage location without knowing the actual storage implementation details.

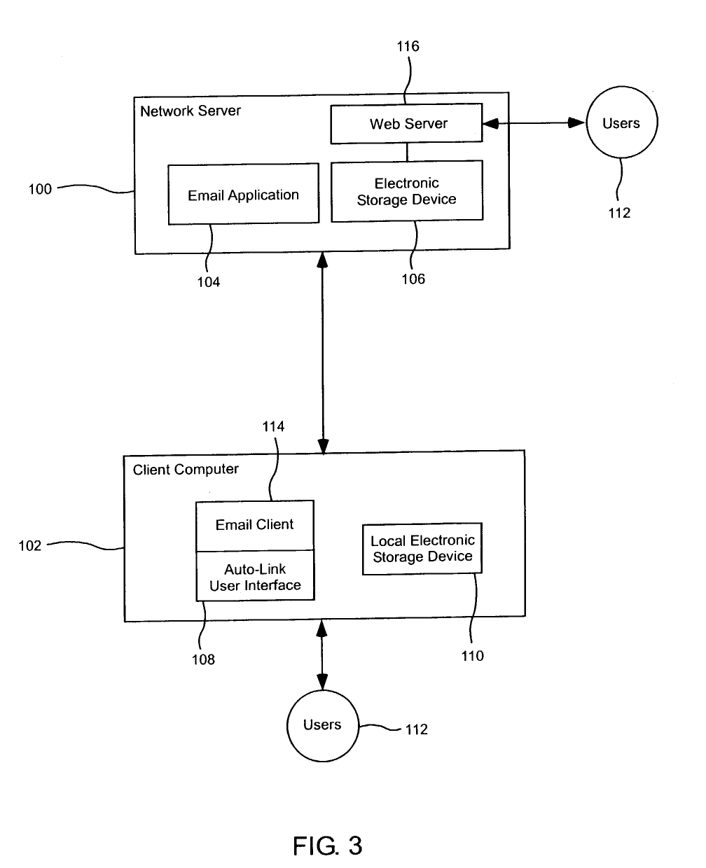

FIG. 3 illustrates a system for associating an attachment file for an email with an access link. The system includes a network server 100 that has an electronic storage device 106. An email application 104 is located on the network server and the email application includes a plurality of emails. Further, the email application can be considered a messaging server for the emails because it receives, stores, and then distributes the emails to email clients. Each of the emails may have one or more attachment files associated with the email. More specific examples of an email application are an email server such as Microsoft Exchange Server®, Lotus Notes®, Novell GroupWise®, or some other email application and database which can receive and distribute email.

A client computer 102 is also provided that has an email client 114. The email client is configured for accessing the plurality of emails in the email application 104 on the network server 100. The email client can connect to the email application and either view or download the emails that are provided via the email application. An auto-link user interface 108 is associated with the plurality of emails for the email client. The auto-link user interface is configured to copy attachment files from an email to a local 110 or networked 106 electronic storage device. Where the attachment file will reside is determined by the user through the auto-link user interface. The auto-link user interface also creates or generates an access link from the email to the attachment file when the auto-link user interface option is activated.

The access link that is associated with the email allows the user to save an attachment file in a specific electronic storage location and then access that attachment file without having to remember where the file was located. This reduces the wasted time a user may spend in finding where an attachment file from an email was saved. Using the present invention, the user can open the original email and immediately know where the attachment file was saved.

The utilization of the access link reduces the possibility that users will save their attachment twice. When users save an attachment twice, it increases and possibly doubles the amount of storage space used on the electronic storage device for attachment files. Thus, the present invention reduces the amount of storage that might otherwise be consumed by the “Save As” email attachment file function.

The present invention provides networking functions for attachment files that have not previously existed. In one embodiment, the access link that is created is a URL hyperlink. This allows the attachment file to be stored on the networked electronic storage location 106. Users 112 can then be located on a remote network and connect to the network server to access the saved attachment file. For example, users may connect to a web server 116 through the Internet and access the stored attachment files from anywhere on the Internet using a networked browser. This embodiment also allows the client email device to access the stored files through the web server, if desired.

In another embodiment of the invention, a separate auto-linking user interface can be provided for accessing the attachment files in an efficient manner. For example, each attachment file saved through the auto-link user interface can be entered into a table or similar graphical interface in order to enhance access to the saved attachments through the web server or email client 114. This condensed list enables the user to navigate just the auto-linked attachment files in one list through the web server or a graphical “pane” in the email client. A short description can be attached to each of the auto-linked attachment files to help a user filter and navigate through the list. Providing a separate user interface avoids filtering back through emails to find the auto-link. In fact, with the condensed interface, the user does not even have to access the auto-linked files through the emails because the auto-linked files are all listed together in a tabular format with the title, sender, date of the email, or some other user created comment.

As discussed previously, the access link may be embedded directly into the email, or the access link may be associated with the email. In the instance where the access link is embedded directly into the email, the access link may be located with the message of the text, in a separate user interface text box, or in a user interface control for the email. In addition, the access link may be provided in the window menus, in a dropdown user selection window, or a similar interface.

The current invention does not require that a user send an actual text message or HTML message to the recipient of the email in order to use the auto-linking function with an email. Even if a user sends an email with no text message, the auto-linking function will be available when an attachment is included with a blank email.

An additional valuable result of the present invention is the reduction of the email folder size on a client computer. Some email systems provide an email client 114 (FIG. 3) on a client computer which can be set to operate in a “remote mode”. The remote mode is used for a laptop or portable computer where the email client is set to connect to the network server and then download emails and attachments. Then a user 112 can access the email client 114 when it is offline, and the user can view the emails and attachment files that have been downloaded.

Since the present invention allows a user to access attachment files through the web server 116 while they are stored in the electronic storage device 106, the email client does not have to download attachment files. These attachment files can simply be stored in a location where they can be accessed through the web server. Thus, when the email client is in remote mode, the email client can connect to a network or to the Internet and these files can be downloaded or accessed through the web server.

When the present invention discusses the term access link or hyperlink, this term is defined relatively broadly. The general definition of a hyperlink is a text reference that points to another point in a document or to a separate document. This is a web style or Internet style link. The present invention includes web style links but the term access link or hyperlink as used in the present invention includes a link to a file on any type of storage device or storage mapping that can be provided by the operating system.

For example, the access link of the present invention can be mapped to a local drive, such as the C: drive, the A: drive, or any other local drive. In addition, there may be other devices which are mapped through the operating system where the email client and the auto-link interface can save attachment files. For example, the auto-link interface can send the attachment file to a mapped network storage drive and have no detailed knowledge of where the actual file is stored, as long as a retrieval request for the file name returns the contents of the file. This means that the present invention can use a network attached storage device (NAS), a network socket, a local removable storage medium, an optical storage medium, a Flash RAM, or any other storage medium that can be mapped by the client computer's or network server's operating systems.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

What is claimed is:

1. A method for associating an attachment file of an email with a separate storage location, comprising the steps of:
storing the attachment file for the email in an electronic storage location;
selecting a user interface option connected to the email to initiate linking of the stored attachment file to the email; and
connecting an access link referencing the stored attachment file to the email in order to link the attachment file in the electronic storage location to the email.

2. A method as in claim 1, further comprising the step of enabling a user to retrieve the attachment file using the access link for the email.

3. A method as in claim 1, further comprising the step of creating an embedded access link when an auto-link user interface option has been selected.

4. A method as in claim 1, further comprising the step of creating the access link within the email using a uniform resource locator (URL) hyperlink which points to the electronic storage location.

5. A method as in claim 1, wherein the step of storing the attachment file further comprises the step of storing the attachment file in a non-volatile electronic storage location.

6. A method as in claim 5, wherein the non-volatile electronic storage location is a hard disk.

7. A method as in claim 1, wherein the step of storing the attachment file further comprises the step of storing the attachment file on a mapped network drive.

8. A method as in claim 1, wherein the step of connecting an access link further comprises the step of embedding an access link in the email that is an internet protocol (IP) address.

9. A method as in claim 1, wherein the step of storing the attachment file further comprises the step of storing the attachment file in a database.

10. A method as in claim 1, wherein the step of storing the attachment file further comprises the step of storing the attachment file in the electronic storage location and enabling the attachment file to be accessed through a web server.

11. A system for associating an attachment file for an email with an access link, comprising:
a network server having an electronic storage device;
an email application located on the network server, the email application including a plurality of emails with attachment files;
a client computer having an email client configured for accessing the plurality of emails in the email application on the network server; and
an auto-link user interface associated with the plurality of emails for the email client and configured to copy the attachment file from an email onto the electronic storage device and to create an access link from the email to the attachment file when an auto-link user interface option has been selected.

12. A system as in claim 11, wherein the access link is a uniform resource locator (URL) hyperlink.

13. A system as in claim 11, wherein the auto-link user interface enables a user to view and access the attachment file using the access link in the email.

14. A system as in claim 11, further comprising an embedded access link that is created in the email when the auto-link user interface has been selected.

15. A system as in claim 11, wherein the access link is inside a user interface component in the email.

16. A system as in claim 11, wherein the attachment file is stored in a non-volatile electronic storage location.

17. A system as in claim 16, wherein the non-volatile electronic storage location is a hard disk.

18. A system as in claim 11, wherein the attachment file is stored on a mapped network drive relative to an email client.

19. A system as in claim 11, wherein the attachment file is stored on local electronic storage.

20. A system as in claim 11, wherein the access link is an embedded internet protocol (IP) address.

21. A system as in claim 11, wherein the attachment file is stored in the electronic storage location and is enabled to be accessed through a web server.

22. A system for associating an attachment file for an email with an access link, comprising:
a network server having an electronic storage device;
an email application located on the network server, the email application including a plurality of emails with attachment files;
a client means for accessing the plurality of emails in the email application on the network server; and
an auto-link means for copying the attachment file from an email onto the electronic storage device and for creating an access link from the email to the attachment file when an auto-link user interface option has been selected in an email.

23. A system as in claim 11, wherein the access link is a uniform resource locator (URL) hyperlink.

24. An article of manufacture, comprising:
a computer usable medium having computer readable program code embodied therein for associating an attachment file of an email with a separate storage location, the computer readable program code means in the article of manufacture comprising:
computer readable program code for storing the attachment file for the email in an electronic storage location;
computer readable program code for selecting a user interface option connected to the email to initiate linking of the stored attachment file to the email;
computer readable program code for connecting an access link referencing the stored attachment file to the email in order to link the attachment file in the electronic storage location to the email; and
computer readable program code for enabling a user to retrieve the attachment file using the embedded access link for the email.
